(19) United States
(12) Patent Application Publication
(10) Pub. No.: US 2008/0217903 A1
(43) Pub. Date: Sep. 11, 2008

(54) Book cover for protecting and handle-carrying books

(76) Inventor: Kendra Ro Bonczar, Milford, NH (US)

Correspondence Address: George W. Dishong Esq.;DISHONG LAW OFFICE, 40 Bryant Road, Jaffrey, NH, 03452, US

(21) Appl. No.: 12/074,839

(22) Filed: Mar. 6, 2008

Related U.S. Application Data
(60) Provisional application No. 60/905,779, filed on Mar. 8, 2007.

(51) Int. Cl. B42D 3/18

(52) U.S. Cl. 281/34

(57) ABSTRACT

Applicant/inventor clearly discovered that book covers could be in a novel and unobvious way, used to carry the book within the book cover if there was included—a carrying handle as a component/feature of the new form of book-carrier-cover. Such book-carrier-cover may be configured so that the means for carrying was a removeably attachable at least one handle system which handle system was removeably attachable to a chosen section of the book cover and which handle system when attached is hideable within or upon the book cover. A plurality of books could be carried that way (1—maybe 3 or 4 depending on the book size) if each book had on such a book-carrier-cover.

### RELATED APPLICATIONS

A provisional application was filed Mar. 8, 2007, for substantially the invention and for the same inventor as described and now claimed herein.

### GOVERNMENT GRANTS/SUPPORT

None

### BACKGROUND & FIELD OF THE INVENTION & DESCRIPTION OF RELATED ART

Book covers as used to cover and thereby protect the hard covers of the books are well known in the field of education and within the area of a substantial amount of use of books especially hard-cover books. The material used for book covers is known. The method of putting a book cover on a book for subsequent substantial use of the book in study or in the transportation or short term storage of the book is also well known and can be achieved by most users of books. Assembly of a book cover on a hard cover book is relatively easy but carrying or transporting the books in use and covered is done in such a manner as to be difficult and somewhat destructive of the nature and appearance of the book cover enclosing the book.

Until Applicant hereof invented the invention as disclosed, defined and now claimed herein, applicant/inventor hereof is unaware of any form of this invention. In the knowledge of inventor, there was no effective way to simply, easily, and cheaply; 1) cover-protect books and consequently because of the features of this invention; 2) carry/transport book or books; and 3) store books in a hang-up position.

Applicant/inventor clearly discovered that book covers could be, in a novel and unobvious way, used to carry the book within the book cover if there was included—a carrying handle as a component/feature of the new form of book-carrier-cover. Such book-carrier-cover may be configured so that the means for carrying was a removeably attachable at least one handle system which handle system was removeably attachable to a chosen section of the book cover and which handle system when attached is hideable within or upon the book cover. A plurality of books could be carried that way (1—maybe 3 or 4 depending on the book size) if each book had on such a book-carrier-cover.

### SUMMARY OF THE INVENTION & DETAILED DESCRIPTION OF THE INVENTION

This application describes and discloses substantially an invention which alters or modifies the design and the function of book covers because the novel and unique character of the device allows for the assembly on a book of a protective book cover and further provides an easy, efficient and effectively comfortable method for carrying the protected book using a handle system. The handle system is a component of the invention may be attachable or may be initially attached i.e., an initially assembled component of the book-carrier-cover substantially the invention herein defined.

It is within the scope of this invention that the handle system may be two handle parts—the first handle part on one segment of the book cover and the second handle part is on the other segment of the book cover and associatively positioned to permit grasping both handle parts with one hand hold. Each of the handle parts may be located substantially at either the top location or the bottom location of the book cover. The top and bottom locations corresponding in position to the top and bottom of a book to which the book cover is attached and in an open and reading position of the book.

It is further within the scope of this invention that the handle system is differently located such as at the front-facing location of the opened book and at both the front section and the rear section of the covered book as being read. The handle system may be identified as a rope-like or a flexible handle system which has at least one handle portion, and attached to the flexible handle portion is a flexible fabric, or rope, or light cord, or even paper which passes through at least one apertures but more preferably two apertures each of which are spaced apart by about the width of the flexible handle portion on both the front section and continues to similarly related rear section apertures and of sufficient length to pass under the binding of a book placed within the book-carrier-cover. Such rope-like or flexible handle system will basically encase and support the book within the cover and carried by the handle system when a very minimal lifting force is used to pick up the book and carry/transport or hang-store the covered book. The apertures are located on both the front-facing section and the rear (facing) section of the book-carrier-cover in such a manner as to not be further from the book binding than is the front edge of the book. Such

It is yet further within the scope of this book cover invention that the handle system comprises only one handle part. The one handle part is configured so as to permit attaching the one handle part from one segment of the book cover to the other segment of the book cover when carrying or storing is to be accomplished. The one handle part may have only an adequate length so as to permit a “loop” form of connection to the other segment. Such methods (line to hook, creating a loop hole and attaching to a button or tab, etc.) will be achievable in many ways and details need not be provide herewith.

It is yet still further within the scope of this book cover invention, inventor clearly notes that the handle system as characterized, may be visible at all times or may be hideable when not needed for storing or for carrying the protected book. Hideable handle system may be a handle system which is foldable with the book or the handle system may be easily attachable and removably configured using any known form of attachment and removement such as VELCRO, snaps, buttons or even zippers.

### BRIEF DESCRIPTION OF THE DRAWINGS

FIG. 1 is a drawing with 2 handles as a non-removeable system and showing the book being covered in dash form and showing this invention in one of the potential location of the handle system of two handle parts positioned at the top or the bottom location for a protected/carryable/stored book, the location of top or bottom being dependent upon the assembly of the book cover on the book panels;

FIG. 2 illustrates a removeably attachable handle system of the invention unassembled to a book to be protected and carried therewith;

FIG. 3 illustrates a single handle form of the invention as a non-removeable system unassembled to a book to be protected and carried therewith and the book being covered shown in the closed position; and

FIG. 4 is an illustration of a rope-like flexible book-carrier-cover 26 and illustrating the book 8 in dashed line form which also represents what could be used as a single handle form removeably attachable rope-like flexible handle system of the invention unassembled to a book but illustrating the locations of the rope.

### DETAILED DESCRIPTION OF THE INVENTION

Applicant/inventor hereof suggests that the invention is a great student need. It is a sturdy, generally made of paper, book cover that preferably consists of two handles for easy carrying very unlike any other known, stretchy covers or just a plain paper bag. The invention makes books easy to carry and makes getting books out of a locker very easy—all you need to do is pull on the handles. This book cover can come in many colors and patterns to fit every personality. Sizes vary also. Whatever book size you have, large or small there is a book cover to fit. Generally the book cover and book carrier of this invention is superior to any other known to the inventor.

Additional to the above description of the invention this device may be provided as a “kit” to attach to books. The kit may have within the set of parts, handles, rope, book cover, means for attaching the handles to the selected surface of the book cover and perhaps VELCRO pads, glue, snaps or any other form of components for use is making attachment of the carrying system to the book cover.

Clearly, there are many ways in which book protection and carrying and storing devices according to this invention can be altered to include the physical attraction elements such as magnets or one magnet and one iron based element in such a manner and in such a most desirable location of each of the members. The materials used to make the book cover, the material for the handle or handles, the methods of attaching etc. are all variable.

The assembly of a book cover 12 to hard cover books 8 especially for the use by students in the process of course-taking is well known to anyone who has participated in the taking of courses. Normally the protected covered books are carried simply by holding the book within the protecting book cover. The invention hereof, does not relate to adhering book covers to books—it relates to having as a component and feature of the protective book cover 12 which new book-carrier-cover 10, when attached to a book 8, provides for ease and comfort and protection of the carried/transported book 8.

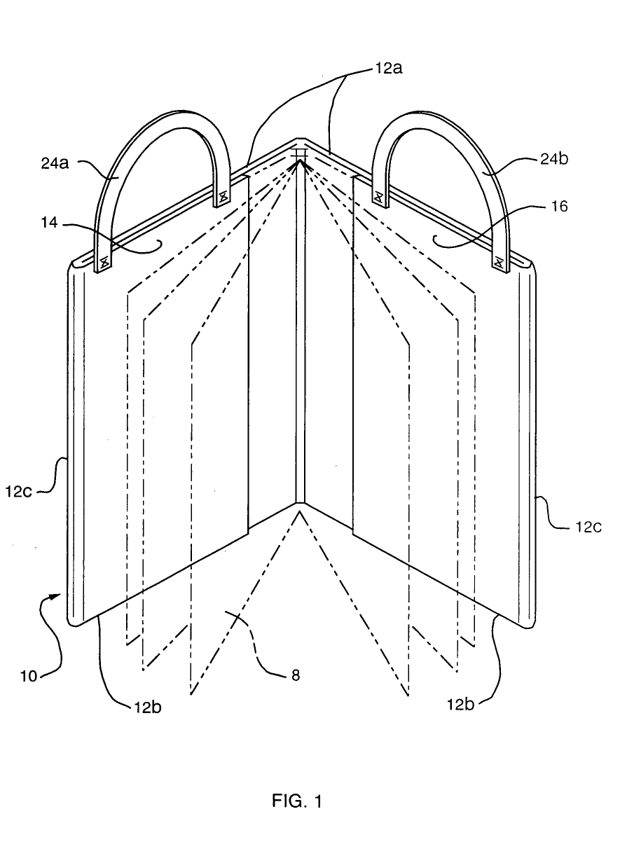

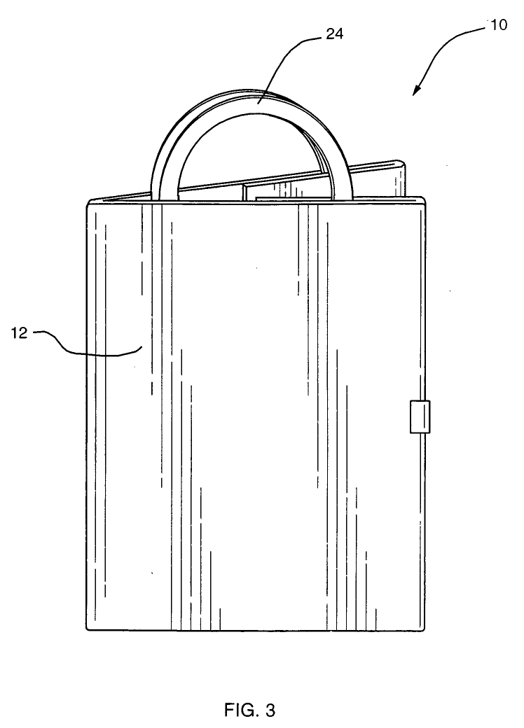

Reference to the drawing FIGS. 1-4 is now provided and each of the Figs. illustrates some of the various forms of the book-carrier-cover 10. FIG. 1 illustrates a protected book 8, the book 8 has a front cover and a back cover and a binder portion. Book 8 has attached thereto substantially the invention hereof in one particular form, book-carrier-cover 10. Book-carrier-cover 10 (BCC 10) is illustrated with the fundamental components thereof, book cover 12 which has top location 12A, a bottom location 12B, and a front location 12C. Also shown is handle system 22 in the form of carrying handle 24 (reference to element 24 is made to FIG. 3 hereof) there being a first handle part 24A on a chosen section 14 of the book cover of the book cover 12 and a second handle part 24B on a chosen section 16 of book cover 12. In FIG. 1 the chosen sections 14 and 16 are at the book cover top location 12A on both the front or book opening side and the back or book closing side. Clearly, the chosen sections 14 and 16 could be the book cover bottom location 12B. It makes very little difference if the book 8 is being carried with the book directed to upwardly are downwardly direction.

An additional option for inclusion with the BCC 10 is a device or means for securing book 8 into a closed position. Illustrated in FIG. 1 is no such means because when holding book 8 using the BCC 10, closure position of the book 8 is accomplished.

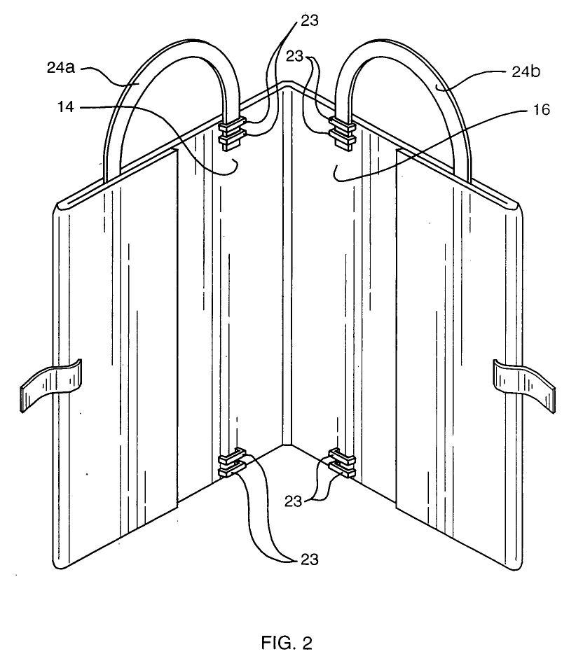

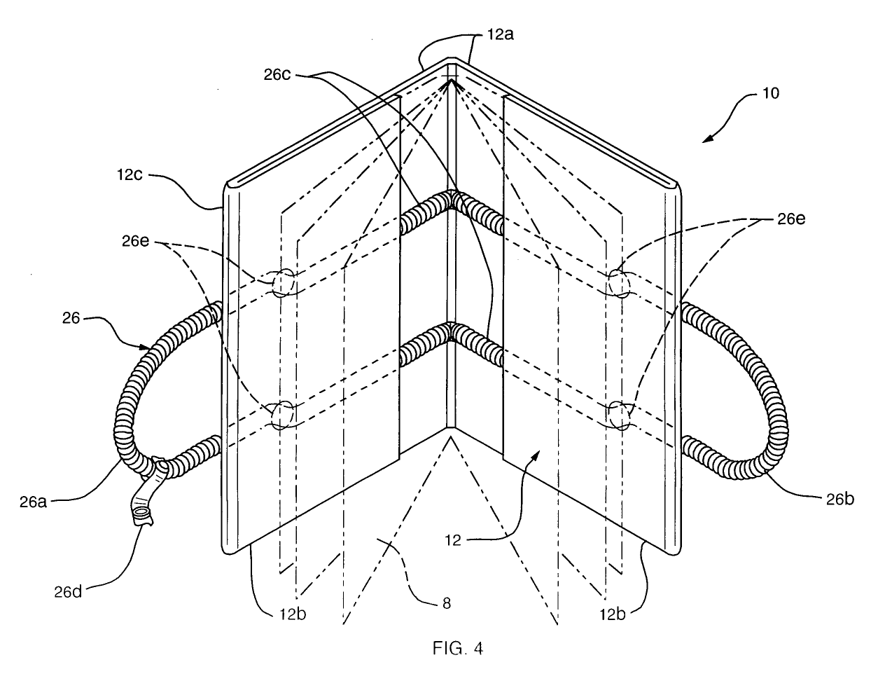

FIG. 2 illustrates a removeably attachable handle system 20 of the invention unassembled to a book 8 to be protected and carried therewith. Each of the carrying handles the first handle part 24A and the second handle part 24B is removeably attachable, using a means for attaching 23 of handle part 24 to a chosen section 14 or 16 of book cover 12 and configured so that upon attaching BCC 10 to book 8 the carrying handle 24 of FIG. 3 is substantially the close combination or association of handle parts 24A and 24B. The plurality of means for attaching 23 may be positioned on the book cover 12 at all or a choice of book cover top location 12A, the bottom location 12B or as seen in FIG. 4 the front location 12C using the rope-like handle system 26. Based upon desirable features, the book cover 12 may have a means to keep book 8 in a closed position and it could be VELCRO pads, snaps, zipper, button and button hole or any other means to keep the book closed. It is not essential to hive such book closed system unless it is desired. The book-carrier-cover 10 will when in carrying or storage use keep book 8 closed.

FIG. 3 is simply a representation of book 8 covered by BCC 10 for which book 8 is in the closed position and showing carrying handle 24 in an upward and a more normal facing direction. The book cover 12 is shown with either the top location 12A or the bottom location 12B in association with handle 24 and the front location 12C position at the opening side of book 8.

FIG. 4 is an illustration of a rope-like flexible book-carrier-cover 26 and illustrating the book 8 in dashed line form. The rope 26C is illustrated as being threaded through 4 apertures each 26E from the outward surface of book cover 12 to the outer surfaces of a book, the book has a book front side and a book back side, each of which is substantially adjacent to a book cover 12 inner surface, the book cover 12 clearly and obviously having a top location 12A, a bottom location 12B, and a front location 12C each of said locations relative to the book 8 outer surfaces. The rope-like flexible/handle system 26 has a removeably assembleable relationship with book cover 12. The rope-like flexible/handle system 26 comprises at least one carrying handle assembleable to a chosen section, illustrated assembled to section 12C of the book cover 12. Clearly any of the sections—top location, the bottom location or the front location 12A or 12B or 12C or all of them may be chosen or selected. The flexible rope-like connection material 26C provided for connection of at least one, call it the first rope handle part 26A and/or the second rope handle part 26B. The connecting rope 26C is also functional as means for providing support for the book being carried. There is also a plurality of apertures 26E for passage therethrough of the connection material 26C from book cover outer surfaces inward toward the book 8 outer surface and subsequent passage to a second aperture positioned adjacent and parallel to a second book side. following passing of the connection material 26C through at least two of the plurality of apertures 26E, there is a knot tying, a snap ring, or other means for connecting 26D the connection material ends.

The advantages of the disclosed invention are clearly apparent to those skilled in the art to which the invention and the related inventions herein referenced. It will become apparent to those skilled in the art to which this present invention pertains and after a study of the description of the invention showing or disclosing many variations of the material of the elements used, and the drawings, and the claims, which claims define the alternative forms of the invention including variations in the location of and the manner of use of the elements within and becoming a part of the book cover and book carrying device.

What I claim is:

1. A book-carrier-cover system comprising:
a book cover attachable to outer surfaces of a book, said book having a book front side and a book back side, each of which is substantially adjacent to a book cover inner surface, said book cover having a top location, a bottom location, and a front location each of said locations relative to said book outer surfaces;
a handle system with a removeably assembleable relationship with said book cover, said handle system comprising at least one carrying handle assembleable to a chosen section of said book cover wherein said chosen section is selected from said top location, said bottom location or said front location; and
means for securely assembling each of said at least one carrying handle to said book cover.

2. A book-carrier-cover system comprising:
a book cover attachable to outer surfaces of a book, said book having a book front side and it book back side, each of which is substantially adjacent to a book cover inner surface, said book cover having a top location, a bottom location, and a front location each of said locations relative to said book outer surfaces;
a rope-like flexible/handle system with a removeably assembleable relationship with said book cover, said rope-like flexible/handle system comprising at least one carrying handle assembleable to a chosen section of said book cover wherein said chosen section is selected from said top location said bottom location or said front location;
flexible rope-like connection material for connection of said at least one carrying handle and for providing support for book carrying;
a plurality of apertures for passage therethrough of said connection material from a book cover outer surfaces inward toward said book outer surface and subsequent passage to a second aperture positioned adjacent and parallel to a second book side; and
means for connecting the connection material ends following passing of said connection material through at least two of said plurality of apertures.

3. A book-carrier-cover system comprising:
a book cover attachable to outer surfaces of a book, said book having a book front side and a book back side, each of which is substantially adjacent to a book cover inner surface, said book cover having a top location, a bottom location, and a front location each of said locations relative to said book outer surfaces; and
a handle system assembled with said book cover, said handle system comprising a first handle and a second handle each affixed to said top location of said book cover, said first handle affixed to said book cover on side parallel to said book front side and the second handle affixed to said book cover on side parallel to said book back side.
